(19) United States
(12) Patent Application Publication
(10) Pub. No.: US 2006/0089944 A1
(43) Pub. Date: Apr. 27, 2006

(54) Automated content posting process

(76) Inventors: Shree A. Dandekar, Round Rock, TX (US); James A. Howell JR., Georgetown, TX (US); Virginia Lucile Montgomery, Austin, TX (US)

Correspondence Address: HAMILTON & TERRILE, LLP, P.O. BOX 203518, AUSTIN, TX, 78720, US

(21) Appl. No.: 10/974,502

(22) Filed: Oct. 27, 2004

(51) Int. Cl. G06F 17/00

(52) U.S. Cl. 707/102

(57) ABSTRACT

A method for automating the posting of content to an online service provider which includes configuring an email account to which content is posted, receiving an email from a user containing content via a predefined email address, determining a user account based upon information contained within the email, and posting the content to the user account.

### BACKGROUND OF THE INVENTION

1. Field of the Invention

The present invention relates to the field of automated photo content posting process.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The need and demand for transferring image data across a network is rapidly increasing. People have started taking pictures using digital cameras. Processing facilities have begun offering digital scanning services as an optional supplemental service of their conventional film processing operations. For example, a customer can request that digitized versions of their film images be written to a diskette, burned onto a CDROM (compact disk read-only memory), or even e-mailed across the internet or made available on an internet web site for downloading by their friends and relatives.

Digital images are stored on various media some that are fixed in location (such as hard disks) and others that can be moved or mailed (such as diskettes, DVDs, or CDROMs). Digital images can also be transferred over communications media such as the internet, local networks, or even a USB (universal serial bus) cable connecting a digital camera to a personal computer.

Known system suppliers, such as Dell, Inc, have become very efficient at delivering customers unique photo service offers along with new computer systems. Often a system supplier provides an option for photo services such as photo services that are ordered during the process of ordering an information handling system. Using the photo service, a customer can instantly upload photographs from a digital camera or computer system or a storage card to the photo service center. Once uploaded, the customer can order prints for any number of photographs.

Known techniques for posting photographs to an online web page and print ordering service are often task-intensive. For example, the image posting software often must be downloaded to the user's computer system. Sometimes this is not possible on a public or shared system and the user must upload photos individually, which can be even slower. Also, often images must be specifically selected from the computer system, camera or storage card and to uploaded. Also, posting photographs can be time consuming (especially over dial-up connections). With known upload techniques, the conversion to web image process occurs during the upload process. If an error occurs during transmission, the user typically must restart the upload process.

### SUMMARY OF THE INVENTION

In accordance with the present invention, a process for automating the posting of content such as image data to an online service provider and into a web-based album is disclosed. Such a process helps in reducing the number of tasks that the user must complete to post content to the web. Such a process also improves the reliability of uploading content online and reduces the time required for uploading and disseminating (distributing and sharing) of the content.

Such a process generally requires fewer tasks and less time than known upload and dissemination techniques. Such a process also advantageously requires no additional software downloads. The process is more reliable than the known upload and dissemination techniques. In the process of the present invention, the upload and conversion of the content to web readable content occurs on the back end of the process, thus saving time for the user. Additionally, the process is less resource intensive for the content service provider.

In one embodiment, the invention relates to a method for automating the posting of content to an online service provider which includes configuring an email account to which content is posted, receiving an email from a user containing content via a predefined email address, determining a user account based upon information contained within the email, and posting the content to the user account.

In another embodiment, the invention relates to a method for automating the posting of content to an online service provider which includes providing a user with a predefined synchronization location within a user information handling system, accessing the predefined synchronization location to determine whether newly added content is present, controlling the user information handling system to automatically upload to newly added content, storing the newly added content to a user account, and posting the content to the user account.

In another embodiment, the invention relates to an apparatus for automating the posting of content to an online service provider which includes means for configuring an email account to which content is posted, means for receiving an email from a user containing content via a predefined email address, means for determining a user account based upon information contained within the email, and means for posting the content to the user account.

In another embodiment, the invention relates to an apparatus for automating the posting of content to an online service provider which includes means for providing a user with a predefined synchronization location within a user information handling system, means for accessing the predefined synchronization location to determine whether newly added content is present, means for controlling the user information handling system to automatically upload to newly added content, means for storing the newly added content to a user account, and posting the content to the user account.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a flow chart of a process for uploading image data using email.

FIG. 3 shows a flow chart of a process for uploading image data via a local folder synchronization technique.

### DETAILED DESCRIPTION

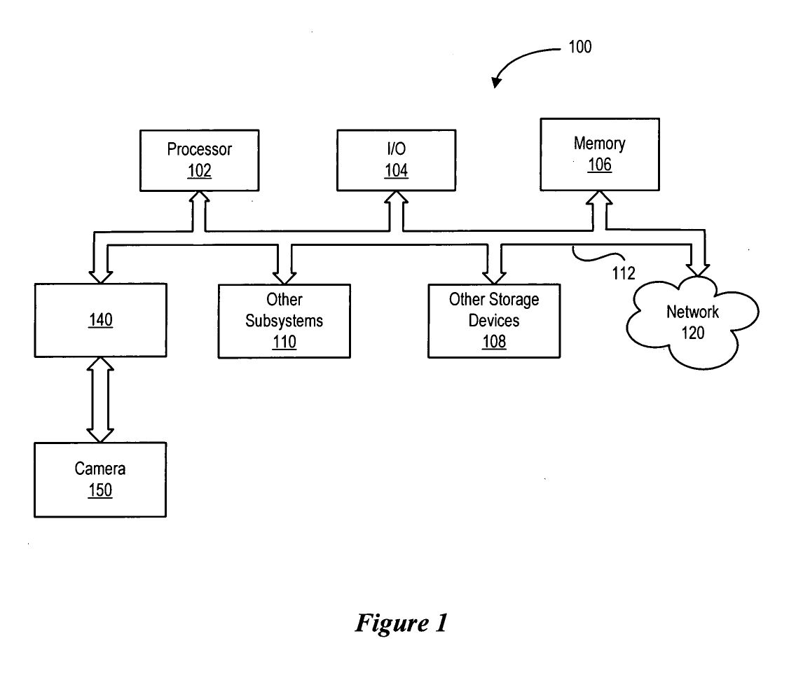

Referring briefly to FIG. 1, a system block diagram of an information handling system 100 is shown. The information handling system 100 includes a processor 102, input/output (I/O) devices 104, such as a display, a keyboard, a mouse, and associated controllers, non volatile memory 106, such as a hard disk and drive, and other storage devices 108, such as a floppy disk and drive and other memory devices, and various other subsystems 110, all interconnected via one or more buses 112. The information handling system 100 may be coupled to a network 120, e.g., via the bus 112. The information handling system may also include a connection device 140 which enables a camera or other type of content (e.g., image data) device to be coupled to the information handling system. For example, the information handling system 120 might include a USB or IEEE 1394 type of connector and controller.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. Additional examples of an information handling system may be a camera or video recorder.

The camera 150 (e.g., a digital camera) enables users to take pictures and save them in digital (electronic) format. The camera 150 enables users to take pictures (i.e., images), which are saved in memory (not shown) within the camera 150 in a digital (electronic) format. After taking and storing the images, the user can connect the digital camera 108 to the information handling system 100 to upload the digital images to the non-volatile memory 106 of the information handling system 100. Once the digital images are uploaded to the information handling system 100, the user can erase the digital images from the memory of the camera 150 so that the user can take and store additional images using the camera 150. Typically, the camera 150 is connected to the information handling system 100 only while the user is uploading images to the non-volatile memory 106 of the information handling system 100.

Users also can obtain digital images, for example, of film-based prints from a film camera, by providing exposed film into a photo-finishing service, which develops the film to make prints and then scans (or otherwise digitizes) the prints or negatives to generate digital image files. The digital image files then can be transmitted back to the user by e-mail or on a CD-ROM, diskette, or other removable storage medium.

After the digital images are stored on the information handing system 100, a user can perform various operations on the digital images. For example, an image viewer application enables viewing the images or a photo editor application enables modifying or touching-up of the images. Also, an electronic messaging (e.g., e-mail) application enables transmission of the digital images to other users.

In addition to viewing the digital images on the display, users often desire to have hard copies (physical prints) made of digital images. Such hard copies can be generated locally by the user using output devices such an inkjet printer or a dye sublimation printer. In addition, users can transmit digital images (e.g., either over a computer network or by using a physical storage medium such as a floppy disk) to a photo-finishing service, which can make hard copies of the digital images and send them (e.g., by U.S. Mail or courier service) back to the user.

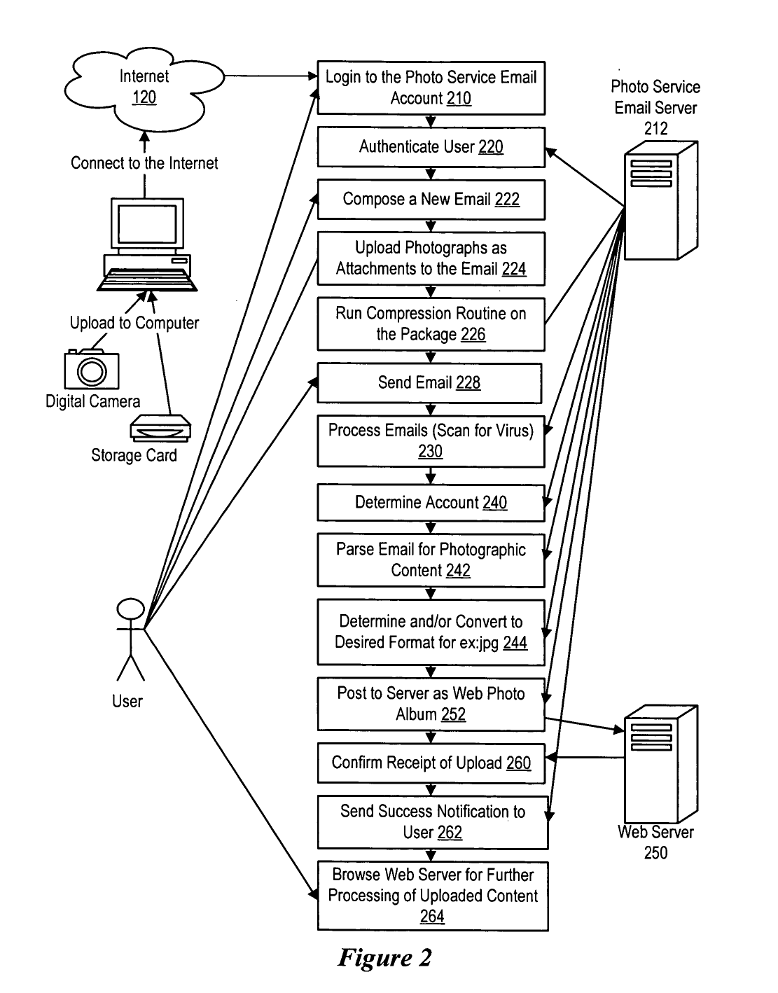

Referring to FIG. 2, a flow chart of a process for uploading content such as image data using email is shown. With the process for uploading image data using email, email images are provided to a specially configured email account that posts the image data to web page. A user configures a service account such as a photo service account that included a list of e-mail addresses with posting privileges. The service assigns one or more custom addresses for photo posting. The service provides the custom address to the user and e-mails the custom address to a primary service e-mail address. When the customer generates the content, the customer can then email the content to the primary content service email address. An authorization e-mail is also sent to the primary e-mail address to prevent spam. Content such as photographs are posted to a general online album where the customer can sort through the content later, if desired.

More specifically, when a user has provided image data onto a user computer system 100, the user may access a service such as a photo service via the internet. When the user accesses the photo service, the user first logs in to a photo service email account at step 210. The photo service email server 212 then authenticates the user at step 220. The user then composes a new email which includes image data that the user wishes to upload to the photo service at step 222. The user then uploads image data such as photographs as attachments to the email at step 224. The photo service email server 212 then executes a compression routine on the attachment to the email, i.e., on the package of uploaded image data at step 226. The user then sends the email to the custom email address at step 228. The photo service email server 212 then processes the email (e.g., scans the email for viruses) at step 230.

The photo service email sever 212 then determines which user account is associate with the email at step 240. The email server then parses the image data (e.g., the photographic content) from the email at step 242. The photo service email server 212 then determines or converts the image data to a desired file format such as a JPEG file format at step 244. The photo service email server 212 then posts the image data to a photo service web server 250 as a photo album at step 252. The web server 250 then confirms receipt of the upload at step 260. The email server then sends an email to the user notifying the user of a successful upload at step 262. The user can then browse the photo services web server for further processing of the uploaded image data at step 264.

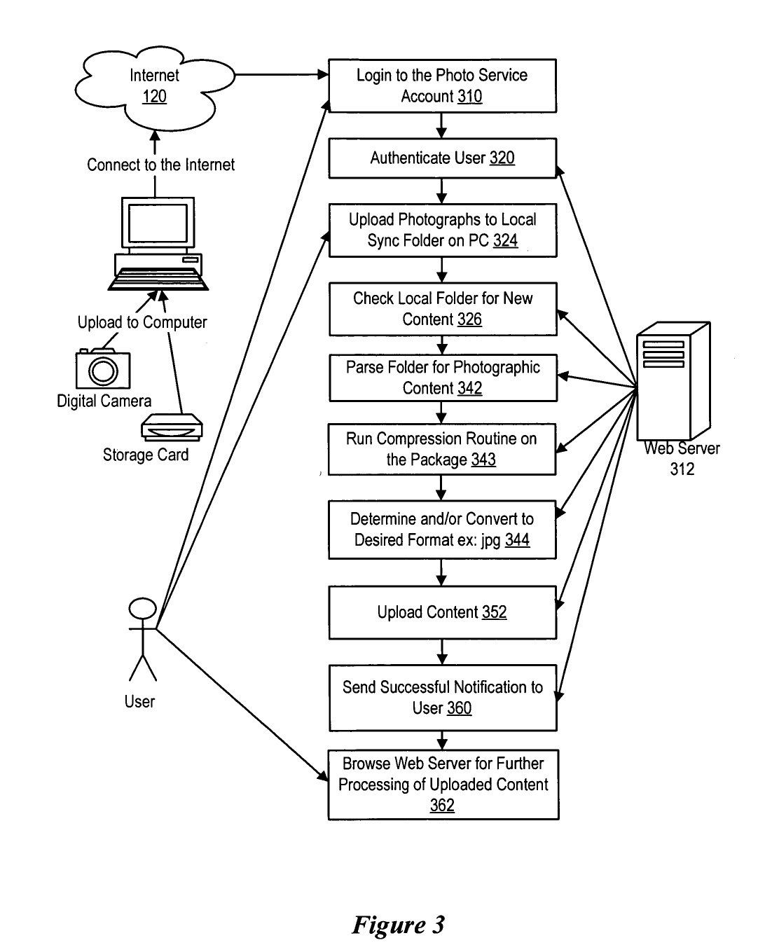

Referring to FIG. 3, a flow chart of a process for uploading image data via a local folder synchronization technique is shown. With the process for uploading image data via a local folder synchronization technique, a user creates a local file that is configured to automatically synchronize with a web page. The customer sets up the photo service account and accesses software that creates a file repository on the desktop. The software can be either downloaded from the photo service provider or preloaded on a system that is ordered (e.g., if a customer orders or indicates interest in a photo service during an order process, the information handling system manufacturer might preload the software onto the information handling system while the information handling system is manufactured. Customers can drag-and-drop images into the file. The file is set up to automatically synchronize or post the images to the web page. The automatic synchronization might be configured to occur during a time when the information handling system is not normally in use, e.g., while the user sleeps. This feature may be important for users that have slower types of internet services.

More specifically, when a user has provided image data onto a user information handling system 100, the user may access a photo service via the internet. When the user accesses the photo service, the user first logs in to a photo service email account at step 310. The photo service web server 312 then authenticates the user at step 320. The user then uploads image data such as photographs to a synchronization location (e.g., a synchronization folder) within the user's computer system at step 324. The photo service web server 312 then accesses the synchronization location to access the newly added content at step 326.

The photo service web sever then parses the synchronization location for image data (e.g., the photographic content) at step 342. The photo service web server 312 then executes a compression routine on the image data at step 343. The photo service web server 312 then determines or converts the image data to a desired file format such as a JPEG file format at step 344. The photo service web server 312 then uploads the image data from the synchronization location to the photo service web server 312 as a photo album at step 352. The web server 312 then confirms receipt of the upload at step 360. The email server then sends an email to the user notifying the user of a successful upload at step 362. The user can then browse the photo services web server 312 for further processing of the uploaded image data at step 364.

### OTHER EMBODIMENTS

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, other types of peripherals (e.g., cameras, personal digital assistants (PDAs), personal movie players, etc.) are contemplated. These other types of peripherals may also include or provide content. For example, a video recorder might include content such as motion data for upload or a voice recorder might include content such as sound data for upload.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for automating the posting of content to an online service provider comprising:
configuring an email account to which content is posted;
receiving an email from a user containing content via a predefined email address;
determining a user account based upon information contained within the email; and,
posting the content to the user account.

2. The method of claim 1 further comprising:
parsing the email for the content.

3. The method of claim 1 further comprising:
authenticating the user before the posting.

4. The method of claim 1 further comprising:
converting the content to a predefined file format.

5. The method of claim 1 further comprising:
scanning the content for viruses before the posting.

6. The method of claim 1 further comprising:
notifying the user of a successful upload of content.

7. The method of claim 1 wherein:
the content includes image data.

8. The method of claim 1 wherein:
the content is received via an information handling system.

9. A method for automating the posting of content to an online service provider comprising:
providing a user with a predefined synchronization location within a user information handling system;
accessing the predefined synchronization location to determine whether newly added content is present;
controlling the user information handling system to automatically upload to newly added content;
storing the newly added content to a user account; and,
posting the content to the user account.

10. The method of claim 9 further comprising:
parsing the synchronization location for the content.

11. The method of claim 9 further comprising:
authenticating the user before the posting.

12. The method of claim 9 further comprising:
converting the content to a predefined file format.

13. The method of claim 9 further comprising:
scanning the content for viruses before the posting.

14. The method of claim 9 further comprising:
notifying the user of a successful upload of content.

15. The method of claim 9 wherein:
the content includes image data.

16. An apparatus for automating the posting of content to an online service provider comprising:
means for configuring an email account to which content is posted;
means for receiving an email from a user containing content via a predefined email address;
means for determining a user account based upon information contained within the email; and,
means for posting the content to the user account.

17. The apparatus of claim 16 further comprising:
means for parsing the email for the content.

18. The apparatus of claim 16 further comprising:
means for authenticating the user before the posting.

19. The apparatus of claim 16 further comprising:
means for converting the content to a predefined file format.

20. The apparatus of claim 16 further comprising:
means for scanning the content for viruses before the posting.

21. The apparatus of claim 16 further comprising:
means for notifying the user of a successful upload of content.

22. The apparatus of claim 16 wherein:
the content includes image data.

23. The apparatus of claim 16 wherein:
the content is received via an information handling system.

24. An apparatus for automating the posting of content to an online service provider comprising:
means for providing a user with a predefined synchronization location within a user information handling system;
means for accessing the predefined synchronization location to determine whether newly added content is present;
means for controlling the user information handling system to automatically upload to newly added content;
means for storing the newly added content to a user account; and,
posting the content to the user account.

25. The apparatus of claim 24 further comprising:
means for parsing the synchronization location for the content.

26. The apparatus of claim 24 further comprising:
means for authenticating the user before the posting.

27. The apparatus of claim 24 further comprising:
means for converting the content to a predefined file format.

28. The apparatus of claim 24 further comprising:
means for scanning the content for viruses before the posting.

29. The apparatus of claim 24 further comprising:
means for notifying the user of a successful upload of content.

30. The apparatus of claim 24 wherein:
the content includes image data.
